(19) United States
(12) Patent Application Publication
(10) Pub. No.: US 2009/0057247 A1
(43) Pub. Date: Mar. 5, 2009

(54) Space-saver pot lid hanging storage pouches

(75) Inventor: James Kraft, San Diego, CA (US)

Correspondence Address: James Kraft, 1037 Essex Street, # 9, San Diego, CA, 92103, US

(73) Assignee: BRENT KRAFT, WEST COVINA, CA (US)

(21) Appl. No.: 11/897,170

(22) Filed: Aug. 30, 2007

(51) Int. Cl. A47J 47/16

(52) U.S. Cl. 211/41.11

(57) ABSTRACT

The present invention relates a pot lid space saving storage unit. This invention is a hanging storage for pot and pan lids. The invention can be made of flexible and sturdy fabrics, plastics, and other synthetic materials. It can also be made of rigid materials such as plastic, metal, or wood. The hanging storage unit has numerous pouches to accommodate the different sizes and shapes of pot lids. The storage unit gradually tapers at the top. Across each pouch is an elastic band that can securely hold the pot lids for those pouches are made of flexible materials. On the back of the flexible pouches are various supporting members that can be used in combination with each other and be removed before washing and be reinserted after washing.

### CROSS-REFERENCE TO RELATED APPLICATION

This part is not applicable.

### BACKGROUND

1. Field of the Invention

The present invention relates a pot lid space saving storage unit that can be hung on the kitchen walls.

2. Description of Prior Art

The standard single residence, town house, condominium or apartment is conspicuously getting smaller. Therefore, the size of the kitchen in these of dwellings has been substantially reduced accordingly. As the modern kitchen is getting smaller, storage is a legitimate concern for all occupants, especially in the areas of pots, pans, and their respective lids.

Pot and pan lids come in various sizes, convexes, weight, and protruding handles. Therefore, it is difficult to design a pot and pan lid holder that can accommodate the various lid shapes. Some lids can be as thin as 1½ inch in total thickness, including the handle on top. Other convex lids can be as thick as 5-10 inches, including the handle on top. Some aluminum lids are relatively light, while other stainless steel and glass lids can weigh several pounds.

There are various pot lid holders or pot lid storage devices on the market, similar to those illustrated in U.S. Pat. No. 4,776,469 (1988) to Geleziunas, U.S. Pat. No. 1,527,744 (1925) to Dix, and U.S. Pat. No. 1,976,476 (1934) to Swanson. However, these devices can not universally accommodate the vast spectrum of sizes, shapes, depths, and weights of the available pot and pan lids on the market today. Freestanding pot lid holders are most likely to topple over because they cannot support the weight of the lids.

Even if the devices available on the market claim that they are universal, they appear cumbersome and complicated, such as the device in U.S. Pat. No. 5,207,334 (1993) to Lear that describes a device of having a base member and a plurality of pot lid holder modules with clasps to hold a pot lid in a scissor-like hold. For a general manufacturer or consumer, the invention appears rather complicated with too many intricate parts. Further, this device will require a significant amount of shelf or counter space.

There are tool storage pouches on the market such as the one described in, U.S. Pat. No. D480,867 (2001) and U.S. Pat. No. D443,411 (2001) all to Snider et al. There are also other storage pouches for smaller personal items such as the one illustrated in U.S. Pat. No. 6,789,665 (2004) to Staiano. Further, there are hanging storage pouches for shoes, laundry, and other household items. However, there is no pot lid hanging storage pouch available on the market.

Therefore, most households do not purchase pot and pan lid holders or storage system due to their shortcomings. The result of that is a cupboard full of lids that can not be stacked on top of each other due to the handles on top of the lids.

### ADVANTAGES OF THE INVENTION

The object of the present invention is to provide a pot and pan lid holder space saver device which is universal in its use that ensures a very sturdy and secured support of pan and pot lids for the modern dwellings. The invention can be manufactured cheaply and feasibly. Further, it can be hung along any surface in the kitchen. This invention can support all types, sizes, shapes and weights of pot and pan lids. Additionally, this invention can be ornamental and stylish in any kitchen. The invention can be washed when dirty.

### SUMMARY OF INVENTION

This invention is a hanging storage for pot and pan lids. The invention can be made of flexible and sturdy fabrics, plastics, and other synthetic materials. It can also be made of rigid materials such as plastic, metal, or wood. The hanging storage unit has numerous pouches to accommodate the different sizes and shapes of pot lids. The storage unit gradually tapers at the top. Across each pouch is an elastic band that can securely hold the pot lids for those pouches are made of flexible materials. On the back of the flexible pouches are various supporting members that can be used in combination with each other and be removed before washing and be reinserted after washing.

### DRAWING FIGURES

FIG. 1: Frontal view of the front side of the invention.

FIG. 2: Side view of the invention.

FIG. 3: Back view of the invention.

### REFERENCE NUMERALS IN DRAWINGS

1. invention
2. hanging means
3. pouch
4. elastic band
5. supporting member
6. pot lid

### DESCRIPTION OF THE PREFERRED EMBODIMENTS

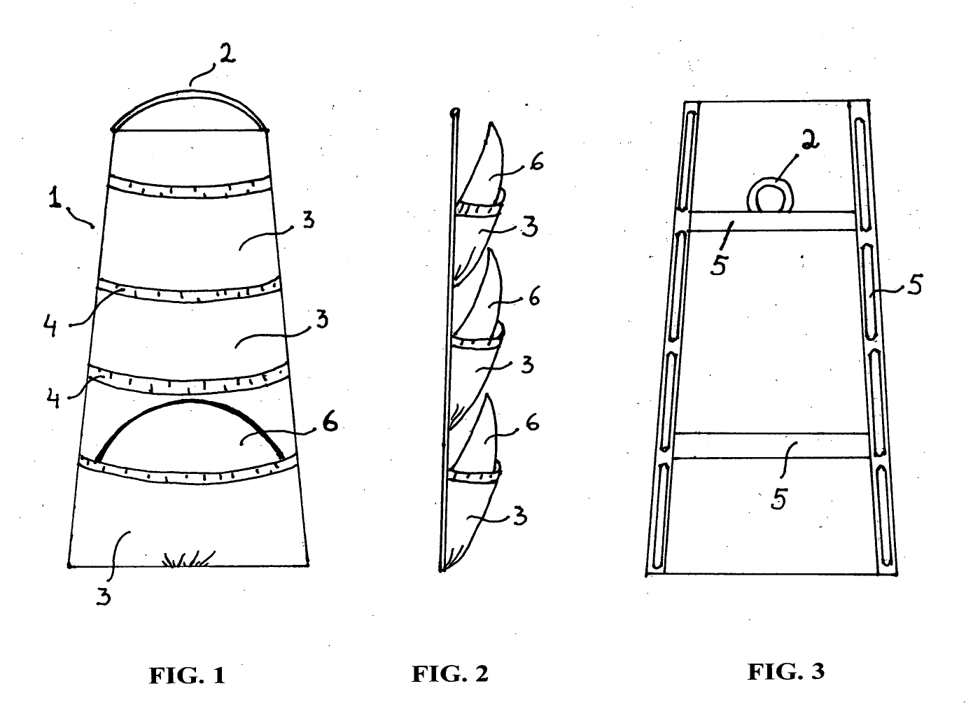

The main body of the pouch 1 gradually tapers at the top, as illustrated in FIG. 1. The invention 1 can be made of any flexible but sturdy material such as fabrics, plastics, and other synthetic materials. The invention 1 can range from 25-40 inches in total length. The width out the invention 1 at the top can range from 7-12 inches. The width of invention 1 at the bottom can range from 14-20 inches. It is desirable to keep the length of the invention 1 to a minimal in order to accommodate the available hanging wall space. Toward the top of the invention 1 there is a hanging means 2 on the back side of the invention 1 in order to hang it on a wall.

On the back of the invention 1 are supporting members 5. These supporting members 5 can be circular or flat stick-like sticks or rods. Further, these supporting members 5 can be continuous sheets of materials that are made of heavier canvas or sturdy materials that can give the invention 1 extra support. There are four spaces to insert these supporting members 5 on the back of the invention 1, as illustrated in FIG. 3. However, it is foreseeable to have 1-5 insertion spaces for supporting members 5, depending on the materials of the invention 1 and the materials of the supporting members 5. There are also two horizontal supporting members to prevent the invention from collapsing in the center. However, if necessary more horizontal supporting members 5 can be used. These supporting members 5 can be removed before washing the invention 1. These supporting members 5 can be easily reinserted before use. Continuous sheets of supporting members 5 can be attached permanently or can be removable on the back of invention 1, depending on the materials used.

There can be 3-5 pouches 3 in the invention 1. The pouches 3 are of sufficient size to universally fit the various sizes of pot lids 6. At the top of the each pouch 3 a heavy-duty elastic band 4 and inside to hold the good in their firm and upright position. Pouches 3 are gathered at the bottom to give puffiness to pouches 3. This gathering can be at the center of pouches 3 or uniformly through out the bottom of pouches 3.

The invention 1 can also be made of rigid materials such as plastic, metal or wood. However, the size of these rigid pouches 3 will change in order to accommodate the various sizes of pot lids 6.

1-4. (canceled)

5. A pot lid holder comprising:
a. a panel formed from a continuous piece of flexible or rigid material having two vertical edges and two horizontal edges;
b. a back supporting means for holding the panel in a rigid form;
c. three to five pouches for holding one pot lid each placed vertically on the panel, one above the other, where each pouch is formed from a flexible material by affixing the vertical edges of the flexible material along the vertical edges of the panel, affixing the bottom edge of the flexible material horizontally across the width of panel, the top edge of the flexible material forming the opening of the pouch and being lined with an elastic band; and
d. hanging means for securing the pot lid holder in a fixed position.

6. The pot lid holder of claim 5 wherein the main panel is wider at the bottom than the top to form a trapezoidal shape to allow pouches of different sizes to be formed vertically along the panel.
